(19) United States
(12) Patent Application Publication
(10) Pub. No.: US 2013/0221855 A1
(43) Pub. Date: Aug. 29, 2013

(54) CONTROLLING BACKLIGHT OF A PORTABLE ELECTRONIC DEVICE

(71) Applicants: Mihal LAZARIDIS, Waterloo (CA); Raymond Michael DIKUN, Red Oak, TX (US); Richard James BROGLE, Irving, TX (US)

(72) Inventors: Mihal LAZARIDIS, Waterloo (CA); Raymond Michael DIKUN, Red Oak, TX (US); Richard James BROGLE, Irving, TX (US)

(73) Assignee: RESEARCH IN MOTION LIMITED, Waterloo (CA)

(21) Appl. No.: 13/404,582

(22) Filed: Feb. 24, 2012

(51) Int. Cl. H05B 37/02

(52) U.S. Cl. 315/149

(57) ABSTRACT

A method of controlling a backlight for illuminating an electronic device, includes: receiving, at a processor of the electronic device, a first input indicating a first user-specified light level of the backlight, the first user-specified light level of the backlight being in association with a first ambient light level, receiving, at the processor, a second input indicating a second user-specified light level of the backlight, the second user-specified light level of the backlight being in association with a second ambient light level, determining a current ambient light level, and controlling the backlight as a function of the current ambient light level, the first user-specified light level of the backlight and the second user-specified light level of the backlight.

### TECHNICAL FIELD

The present application relates to backlighting of portable electronic device displays, buttons and keyboards.

### BACKGROUND DISCUSSION

Electronic devices, including portable electronic devices, have gained widespread use and can provide a variety of functions including, for example, telephonic, electronic messaging and other personal information manager (PIM) application functions. Portable electronic devices can include several types of devices including mobile stations such as simple cellular telephones, smart telephones, wireless PDAs, tablets and laptop computers with wireless 802.11 or Bluetooth capabilities. These devices run on a wide variety of networks from data-only networks such as Mobitex and DataTAC to complex voice and data networks such as GSM/GPRS, CDMA, EDGE, UMTS and CDMA2000 networks.

Devices such as PDAs, smart telephones or tablets are generally intended for handheld use and ease of portability. Smaller devices are generally desirable for portability. Touch screen devices may be useful on handheld devices as such handheld devices are small and are therefore limited in space available for user input and output devices.

### BRIEF DESCRIPTION OF THE DRAWINGS

Embodiments of the present application will now be described, by way of example only, with reference to the attached Figures, wherein:

FIG. 1 is a simplified block diagram of one example of a portable electronic device in accordance with the present disclosure;

FIG. 2 is a simplified block diagram of one example of backlight control apparatus in accordance with the present disclosure;

FIG. 3 is a flowchart illustrating a method of controlling a backlight for illuminating a portable electronic device in accordance with the present disclosure; and

FIG. 4 is a graph depicting a light level of a backlight corresponding to ambient light level.

### DETAILED DESCRIPTION

In an aspect of the present disclosure there is provided a method of controlling a backlight for illuminating an electronic device, including: receiving, at a processor of the electronic device, a first input indicating a first user-specified light level of the backlight, the first user-specified light level of the backlight being in association with a first ambient light level; receiving, at the processor, a second input indicating a second user-specified light level of the backlight, the second user-specified light level of the backlight being in association with a second ambient light level; determining a current ambient light level; and controlling the backlight as a function of the current ambient light level, the first user-specified light level of the backlight and the second user-specified light level of the backlight.

In another aspect of the present disclosure there is provided an electronic device including: a light sensor; a processor in electrical communication with the light sensor for determining a current ambient light level, receiving a first input indicating a first user-specified light level of the backlight, the first user-specified light level of the backlight being in association with a first ambient light level and receiving a second input indicating a second user-specified light level of the backlight, the second user-specified light level of the backlight being in association with a second ambient light level; a backlight in electrical communication with the processor, the backlight controllable as a function of the current ambient light level, the first user-specified light level of the backlight and the second user-specified light level of the backlight.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

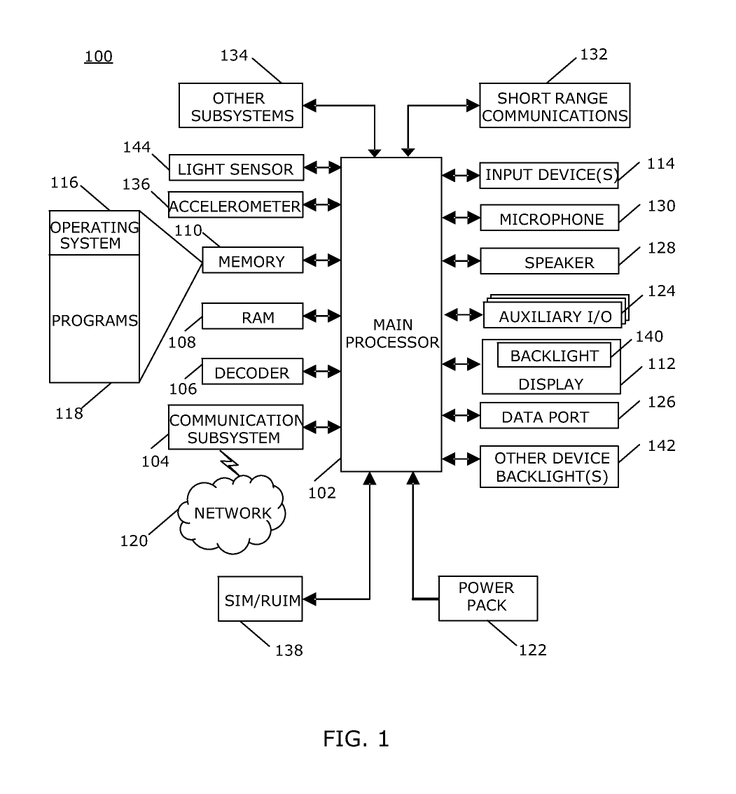

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 120. The wireless network 120 may be any type of wireless network, including, but not limited to, data wireless networks, voice wireless networks, and networks that support both voice and data communications.

The processor 102 interacts with other components, such as Random Access Memory (RAM) 108, memory 110, an input device 114, such as a keyboard, device buttons or navigation devices, for example, an auxiliary input/output (I/O) subsystem 124, the data port 126, a speaker 128, a microphone 130, short-range communications 132, and other device subsystems 134. The processor 102 may interact with an orientation sensor such as an accelerometer 136 that may be utilized to detect direction of gravitational forces or gravity-induced reaction forces. A power pack 122, such as one or more rechargeable batteries or a port to an external power supply, powers the portable electronic device 100.

The processor 102 further interacts with a display 112, which includes a backlight 140, and other device backlight(s) 142. The display 112 may be a liquid crystal display (LCD) or other non-touch-sensitive display, such as an OLED (organic light-emitting diode), for example. Alternatively, the display 112 may be a touch-sensitive display. The touch-sensitive display may be capacitive, resistive, infrared, a surface acoustic wave (SAW) touch-sensitive display, strain gauge, optical imaging, dispersive signal technology or acoustic pulse recognition, for example. The other device backlight(s) 142 may selectively light the keyboard, individual device buttons, groups of device buttons or a message indicator light, for example. For purposes of illustration, it may be assumed that the display backlight 140 and other backlights 142 may be set or adjusted or customized in tandem; but the concepts described herein may also be applied so that display backlight 140 and other backlights 142 can be customized independently of one another.

To identify a subscriber for network access, the portable electronic device 100 uses a Subscriber Identity Module or a Removable User Identity Module (SIM/RUIM) card 138 for communication with a network, such as the wireless network 120. Alternatively, user identification information may be programmed into memory 110.

The portable electronic device 100 includes an operating system 116 and software programs or components 118 that are executed by the processor 102 and are typically stored in a persistent, updatable store such as the memory 110. Additional applications or programs may be loaded onto the portable electronic device 100 through the wireless network 120, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 120 through the communication subsystem 104. For voice communications, the overall operation of the portable electronic device 100 is similar. The speaker 128 outputs audible information converted from electrical signals, and the microphone 130 converts audible information into electrical signals for processing.

A light sensor 144 electrically communicates with the processor 102 to provide an ambient light level, which may be measured in lux (lx). The light sensor 144 is mounted in a housing of the portable electronic device 100 at a location at which it is exposed to ambient light. In some portable electronic devices 100, the light sensor is located at a top end of the housing. In some portable electronic devices 100, there may be more than one light sensor, or the light sensor may have functions in addition to generating light level data or any other signal as a function of the detected or measured ambient light level.

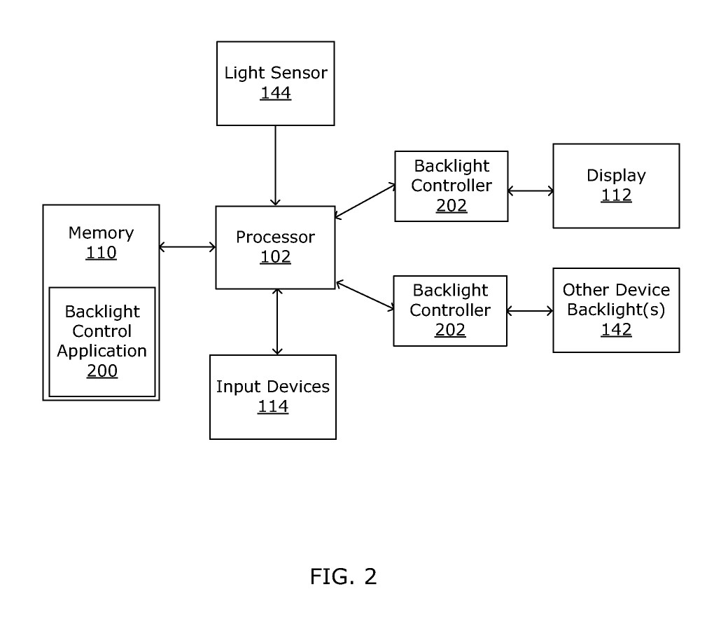

Referring to FIG. 2, a backlight control application 200 is stored in memory 110 as computer readable code and is executable by the processor 102. The backlight control application 200 controls the operation of one or more backlights of the portable electronic device 100 via backlight controllers 202, which are hardware component in electrical communication with the display 112 and other backlight devices 142, as shown. The number of backlight controllers 202 is determined based on the number of individually controllable backlights of the portable electronic device 100.

The processor 102 receives light level data from the light sensor 144. The ambient light level may be a value in lux units, for example, or a percentage between no light and full light. In a typical implementation, an ambient light level is not meaningful as a single number, but as a range of numbers. For example, two ambient light levels may both be deemed the same (e.g., they may both be deemed “dim”) even though their lux levels are different, if they are in the same range. Optionally, the ranges may overlap (such that a lux level may be deemed to be either “dim” or “office,” for example). The light sensor 144 may be an 8-bit light sensor capable of differentiating between 256 shades of brightness. Other types of light sensors 144 may alternatively be used including a 10-bit light sensor, or a 12-bit light sensor, for example. The ambient light level data may be sent to the backlight control application 200 at intervals so that the light level of the backlight does not significantly lag a change in ambient light level.

The backlight control application 200 receives input indicating a light level of a backlight. Generally speaking, an input indicating a light level of a backlight is an input from a user expressing a preference about backlighting under certain levels of ambient light. The backlight control application 200 may receive one or more inputs indicating a light level of a backlight via one or more of from the input devices 114 or the display 112, when the display 112 is a touch-sensitive display. The backlight control application 200 may alternatively receive input indicating a user-selected light level of a backlight from the microphone in portable electronic devices capable of executing voice commands, for example. By way of illustration, the display 112 may show a user a dialog box or a menu or graphical user interface and ask the user to express a preferred backlighting for (that is, in association with) a corresponding level of ambient light. The user may be asked, for example, “In an outdoor environment with bright sunlight, how bright should the screen and keyboard illumination be?” The user may enter the preference in any way, such as by moving a graphical slider or selection of an option. Options may be presented as, for example, icons or numeric gradations or percentages or comparatives (such as “Brighter-Darker”) or word gradations (such as “Very Low-Low-Medium-High-Very High”) or any variation or combination thereof. The concepts described herein are not limited to any particular number of gradations or to any particular user interface by which a user may express lighting preferences. Optionally, the user may be informed of the current ambient light level and different levels of backlighting may be demonstrated so that the user may select a desired degree of backlighting. Optionally, there may be default settings for levels of backlighting. The user's input may include a “save setting” confirmation following adjustment of the backlight using a backlight control user interface of the portable electronic device. The inputs need not be the same for different levels of ambient light. For example, a user may express a preference for very high backlighting in “outdoor” (or very sunny) conditions, but express a preference for medium backlighting in “dim” conditions. In other words, the backlight control application 200 may receive different user-selected backlight light level inputs indicating different light levels of a backlight in association with different levels of ambient light.

The backlight control application 200 stores, in the memory 110, information associating user-selected backlight light levels and corresponding ambient light levels. The backlight control application 200 retrieves light levels of the backlight and the backlight light levels are sent to the backlight controllers 202 of the display 112 and/or other device backlight(s) 142 in order to output backlight levels that correspond to current ambient light levels.

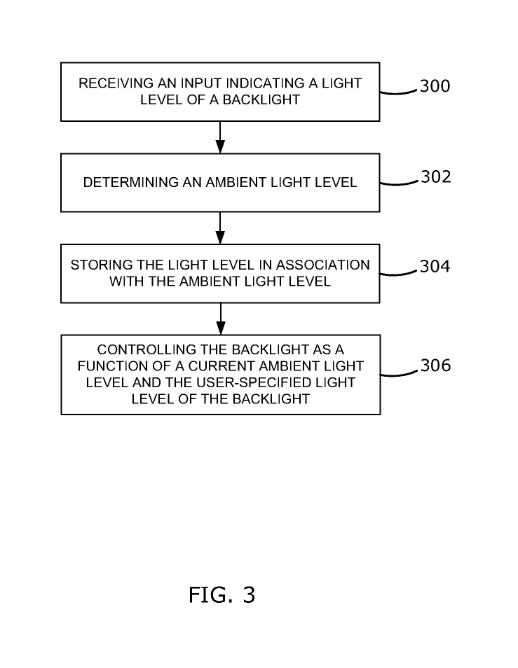

A flow chart illustrating a method of controlling a backlight for illuminating a portable electronic device 100, is shown in FIG. 3. The steps of FIG. 3 may be carried out by routines or subroutines of software executed by, for example, the processor 102. Coding of software for carrying out such steps is well within the scope of a person of ordinary skill in the art given the present description. Computer-readable code executable by at least one processor of the portable electronic device to perform the method may be stored in a computer-readable medium, such as a non-transitory computer-readable medium.

The portable electronic device 100 receives 300 an input indicating a light level of a backlight, the input is associated with a user-preferred backlight light level for a particular ambient light level. The ambient light level may be the current ambient light level or another light level. For example, in one implementation, a user may select a backlight level (and supply an input that reflects that selection) for the current level of ambient light in which the user resides at the moment. In another implementation, the user may select a backlight level for a dim environment (for instance), even though the level of ambient light is not actually dim at the time. In a typical implementation, however, a user may select a first backlight level for the current ambient light level at a first time, and select a second backlight level for the current ambient light level at a second time. The ambient light level is substantially contemporaneously or later (later may include, but is not necessarily limited to, occurring promptly thereafter) determined 302 using the light sensor 144. The ambient light level may be determined 302 in response to an input indicating a light level of the backlight or in response to the backlight control user interface being invoked, or in response to any other stimulus. Alternatively, the ambient light level may be continuously (or substantially continuously, e.g., at frequent intervals) monitored so that an ambient light level value determined at the time the input was received may be used.

The light level of the back light is then stored 304 in association with the (current or other) ambient light level. In some cases, storage 304 may precede determining 302 the ambient light using the light sensor 144. The light level of the backlight and corresponding ambient light level may be stored in a table in the memory 110 that includes manufacturer default backlight settings and backlight light levels that have previously been input based on user-selection along with corresponding ambient light levels. Once stored, calculations may be performed on the information in order to facilitate efficient retrieval, from the memory 110, a current backlight level based on a current ambient light level.

In one example, no calculations are performed when the information is stored, however, when a current ambient light level is determined, a current backlight level is retrieved from the table. Linear interpolation may be performed when no matching ambient light level is available. In another example, a lookup table of backlight levels and/or manufacturer default settings vs. corresponding ambient light levels is re-calculated using straight line interpolation when a new user-selected backlight level is received. In another example, the backlight light level and corresponding ambient light level are used to define (or refine) coefficients of a function representing the manufacturer default settings, the backlight light levels input based on user-selection and corresponding ambient light levels. The function may be determined based a piecewise linear, a piecewise spline fitting or a polynomial curve fitting method.

In the example methods of storing the light level of the backlight and corresponding ambient light level described, when the corresponding ambient light level of the light level has previously been defined by the user or the manufacturer, the previously defined backlight level of the corresponding ambient light level may be overwritten.

For ambient light levels other than the ambient light level determined at step 302, received light level inputs are maintained in association with corresponding determined ambient light levels. By maintaining previously received user-specified light levels in memory, a database of user-specified light level inputs and associated ambient light levels may be developed over time to define light levels of backlight for many different ambient lighting conditions.

Referring still to FIG. 3, the backlight is controlled 306 as a function of a current ambient light level and one or more user-preferred backlight light levels associated with ambient light levels previously stored in memory. When only one input indicating the light level of the backlight is received prior to step 306, the backlight may be controlled 306 as a function of the current ambient light level, the one user-specified light level of the backlight and one or more manufacturer default backlight settings, which are stored in memory. In one implementation, the backlight is controlled as a function of the current ambient light level, the first user-specified light level of the backlight and the second user-specified light level of the backlight.

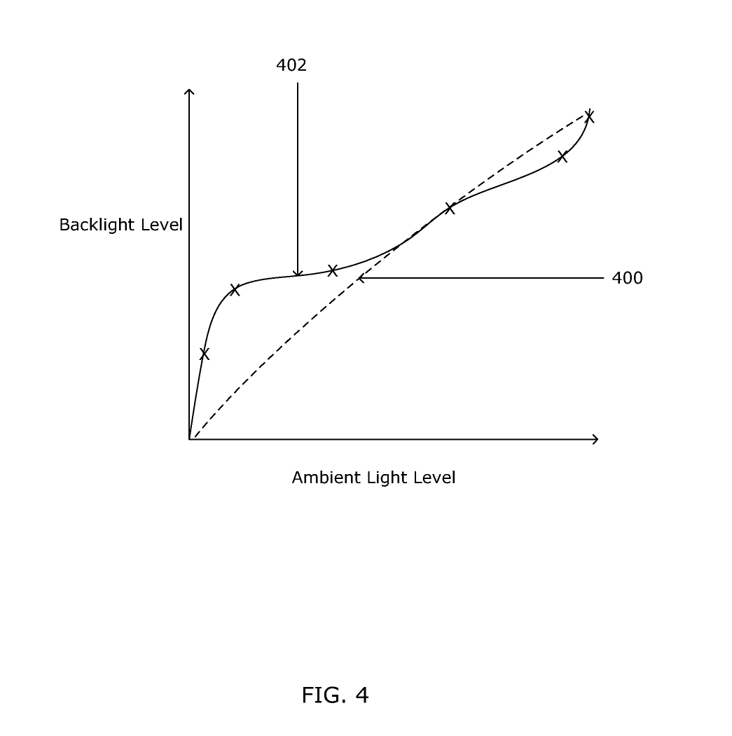

In operation, the steps 300, 302 and 304 of method of FIG. 3 are followed in order to customize backlight control of a component of the portable electronic device 100, such as the display 112, for example. When ambient light level data is received by the backlight control application 200, the backlight is controlled by accessing the memory 110 in order to retrieve the light level of backlight associated with the ambient light level. How the light level of backlight associated with an ambient light level is retrieved is based on whether or not calculations were performed to facilitate retrieval of the light level of the backlight. In the example in which the information is stored as discreet backlight light levels and corresponding ambient light levels, interpolation between stored values in order to determine a backlight light level associated with a current ambient light level is determined. In the example in which the information is stored in a lookup table, the backlight level corresponding to the current ambient light level is retrieved from the lookup table. In the example in which the function and coefficients are stored in the memory 110, the backlight light level is calculated by entering the current ambient light level into the curve function. In this example, the function may be similar to curve 402 of FIG. 4. Curve 402 fits user-entered light inputs, which are indicated by X's. A manufacturer setting default curve 400 is shown for reference. Typically, the manufacturer setting default curve 400 is a straight line that is defined by a start point and an end point, as shown. In one example, a user may manipulate the manufacturer setting default curve 400 in order to change the shape, and therefore, customize many points on the curve at one time. Colloquially speaking, by inputting two or more user-specified light levels in association with a two or more ambient light levels, the user can “draw the user's own curve,” which may be different from the manufacturer's curve. The electronic device controls the backlight as a function of “the user's own curve.”

Any of the methods of storing backlight light levels and corresponding ambient light levels described may be used in combination with one or more other methods.

In one embodiment, following storage of a new user-selected backlight level and corresponding ambient light level, whether or not subsequent calculations are performed is determined based on available processing capability. For example, when the user adjusts the backlight on the portable electronic device 100 at a time when multiple applications are running or a large amount of data is being downloaded via a wireless connection, the backlight level is stored in a table and no calculations are performed. Calculating a lookup table or determining coefficients of a function may be performed at a later time when the processor has more available processing capability.

Components that are backlit appear to have light emanating from behind the component. It will be appreciated that the term “backlight” is not limited to a light source that is physically behind the backlit component. The backlit component may be lit from the side, top or bottom, for example, to achieve the same backlighting effect.

The method and apparatus described herein may realize one or more advantages, some of which may have already been described. Rather than dividing the ambient light levels into groups including “dim”, “office” and “outdoor”, for example, each ambient light level may have its own corresponding backlight light level. Moreover, the degree of backlighting for each ambient light level may be individually and easily customized. By providing increased backlight customization capability, user experience may be improved. Individual users' preferences and eyesight may be readily accommodated. Further, the concepts may be implemented in a variety of electronic devices having a variety of sizes and capabilities. Portable electronic devices may be more likely than other electronic devices to be transported into environments that have different—perhaps even vastly different—ambient lighting conditions. The concepts may be especially beneficial for users who desire to set backlight levels each time they move into a different ambient lighting environment. A user who feels, for example, that the manufacturer default backlight settings is fine for an office setting, but the default outdoor setting is too bright and the default dim setting is not bright enough, can readily change the backlight settings to accommodate the user's own preferences. In some cases, where users operate in specialized or individualized lighting environments, the backlights may be set to work with such specialized or individualized lighting environments.

In some embodiments, the concept of ranges of ambient light becomes unnecessary. A user who has made inputs so as to “draw the user's own curve” may have, in effect, a desired backlight level for every ambient light level. Furthermore, with the application of interpolation or other mathematical operations, the user may have a desired backlight level for a specific ambient light level, even if the user did not specify the desired backlight level for that specific ambient light level. Also, a user whose own curve is smooth may see smooth backlighting transitions or changes (or perhaps no perceived change at all) as current ambient light levels change.

The above-described embodiments are intended to be examples only. Alterations, modifications and variations can be effected to the particular embodiments by those of skill in the art without departing from the scope of the present application, which is defined solely by the claims appended hereto.

What is claimed is:

1. A method of controlling a backlight for illuminating an electronic device, comprising:
receiving, at a processor of the electronic device, a first input indicating a first user-specified light level of the backlight, the first user-specified light level of the backlight being in association with a first ambient light level;
receiving, at the processor, a second input indicating a second user-specified light level of the backlight, the second user-specified light level of the backlight being in association with a second ambient light level;
determining a current ambient light level; and
controlling the backlight as a function of the current ambient light level, the first user-specified light level of the backlight and the second user-specified light level of the backlight.

2. A method as claimed in claim 1, wherein the first user-specified light level of the backlight is stored in association with the first ambient light level and the second user-specified light level of the backlight is stored in association with the second ambient light level in a table in memory.

3. A method as claimed in claim 1, wherein for ambient light levels other than the first ambient light level and the second ambient light level, maintaining received user-specified light levels of the backlight in association with corresponding ambient light levels in memory.

4. A method as claimed in claim 1, wherein a lookup table is calculated based on the first user-specified light level of the backlight, the first ambient light level, the second user-specified light level of the backlight and the second ambient light level.

5. A method as claimed in claim 2, wherein coefficients of a function are calculated based on the table.

6. A method as claimed in claim 5, wherein the function is determined based on one of: a piecewise linear method, a piecewise spline fitting method or a polynomial curve fitting method.

7. A method as claimed in claim 5, wherein a current light level of the backlight is calculated using the function, the coefficients and the current ambient light level.

8. A method as claimed in claim 1, comprising interpolating between the first user-specified light level of the backlight and the second user-specified light level of the backlight when the current ambient light level is between the first ambient light level and the second ambient light level.

9. A method as claimed in claim 1, comprising setting a current light level of the backlight to the first user-specified light level of the backlight when the current ambient light level matches the first ambient light level.

10. A method as claimed in claim 1, wherein the current ambient light level is determined by the processor in electrical communication with a light sensor.

11. A non-transient computer-readable medium comprising instructions executable on the processor of the electronic device for implementing the method of claim 1.

12. An electronic device comprising:
a light sensor;
a processor in electrical communication with the light sensor for determining a current ambient light level, receiving a first input indicating a first user-specified light level of the backlight, the first user-specified light level of the backlight being in association with a first ambient light level and receiving a second input indicating a second user-specified light level of the backlight, the second user-specified light level of the backlight being in association with a second ambient light level;
a backlight in electrical communication with the processor, the backlight controllable as a function of the current ambient light level, the first user-specified light level of the backlight and the second user-specified light level of the backlight.

13. An electronic device as claimed in claim 12, wherein the first user-specified light level of the backlight is stored in association with the first ambient light level and the second user-specified light level of the backlight is stored in association with the second ambient light level in a table in memory.

14. An electronic device as claimed in claim 12, wherein for ambient light levels other than the first ambient light level and the second ambient light level, maintaining received user-specified light levels of the backlight in association with corresponding ambient light levels in memory.

15. A method as claimed in claim 13, wherein coefficients of a function are calculated based on the table.
